(19) United States
(12) Patent Application Publication
(10) Pub. No.: US 2009/0184977 A1
(43) Pub. Date: Jul. 23, 2009

(54) MULTI-FORMAT SUPPORT FOR SURFACE CREATION IN A GRAPHICS PROCESSING SYSTEM

(75) Inventors: Steven Todd Weybrew, Portland, OR (US); Brian Ellis, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/116,060

(22) Filed: May 6, 2008

Related U.S. Application Data
(60) Provisional application No. 61/022,193, filed on Jan. 18, 2008.

(51) Int. Cl. G09G 5/02

(52) U.S. Cl. 345/604; 345/589; 345/600

(57) ABSTRACT

In general, the present disclosure describes various techniques for creation of surfaces using a platform interface layer wherein such surfaces may have different format layouts for various different color spaces, such as the YCbCr color space. One example device includes a storage device configured to contain surface information and one or more processors configured to create a graphics surface within a color space using a platform interface layer. The platform interface layer lies between a client rendering application program interface (API) and an underlying native platform rendering API. The one or more processors are further configured to specify a format layout of data associated with the surface within the color space using the platform interface layer and to store the format layout within the storage device. The format layout indicates a layout of one or more color components of the data associated with the surface within the color space.

### RELATED APPLICATIONS

This application claims the benefit of U.S. Provisional Application No. 61/022,193, filed on Jan. 18, 2008, the entire contents of which is incorporated herein by reference.

### TECHNICAL FIELD

This application relates to rendering and display of surfaces within a graphics processing system.

### BACKGROUND

Graphics processors are widely used to render two-dimensional (2D) and three-dimensional (3D) images for various applications, such as video games, graphics programs, computer-aided design (CAD) applications, simulation and visualization tools, and imaging. Display processors may then be used to display the rendered output of the graphics processor for presentation to a user via a display device.

Graphics processors, display processors, or multi-media processors used in these applications may be configured to perform parallel and/or vector processing of data. General purpose CPU's (central processing units) with or without SIMD (single instruction, multiple data) extensions may also be configured to process data. In SIMD vector processing, a single instruction operates on multiple data items at the same time.

OpenGL® (Open Graphics Library) is a standard specification that defines an API (Application Programming Interface) that may be used when writing applications that produce 2D and 3D graphics. (Other languages, such as Java, may define bindings to the OpenGL API's through their own standard processes.) The interface includes multiple function calls that can be used to draw scenes from simple primitives. Graphics processors, multi-media processors, and even general purpose CPU's can then execute applications that are written using OpenGL function calls. OpenGL ES (embedded systems) is a variant of OpenGL that is designed for embedded devices, such as mobile wireless phones, digital multimedia players, personal digital assistants (PDA's), or video game consoles. OpenVG™ (Open Vector Graphics) is another standard API that is primarily designed for hardware-accelerated 2D vector graphics.

EGL™ (Embedded Graphics Library) is a platform interface layer between multi-media client API's (such as OpenGL ES, OpenVG, and several other standard multi-media API's) and the underlying platform multi-media facilities. EGL can handle graphics context management, rendering surface creation, and rendering synchronization and enables high-performance, hardware accelerated, and mixed-mode 2D and 3D rendering. For rendering surface creation, EGL provides mechanisms for creating surfaces onto which client API's (such as user application API's) can draw and share. Currently, EGL provides support only for linear and sRGB (standard red green blue) surfaces.

### SUMMARY

In general, the present disclosure describes various techniques for creation of surfaces using a platform interface layer, such as EGL, wherein such surfaces may have different format (or packing) layouts for various different color spaces, such as the RGB (red, green, blue) or YCbCr (luma, blue chroma difference, red chroma difference, wherein the Cb and Cr signals are deltas form the Y signal) color spaces. In certain cases, YCbCr EGL surfaces may be used with OpenGL and OpenVG surfaces, and may be combined within a surface overlay stack for ultimate display on a display device, such as an LCD (liquid crystal display) or television (TV) display device.

In this manner, various 2D, 3D, and/or video surfaces in different color spaces may be ultimately combined for display on the display device. In certain cases, this functionality and support may be provided as part of a platform interface layer extension, such as an EGL extension. The extension may further provide conversion information to aid in the conversion of YCbCr surfaces, e.g. JPEG (Joint Photographic Experts Group) surfaces or MPEG4 (Moving Picture Experts Group version 4) surfaces, into the RGB color space, which may be useful for display of such surfaces.

In one aspect, a method includes creating a graphics surface via a platform interface layer that lies between a client rendering application program interface (API) and a native platform rendering API. The method further includes specifying a format layout of data associated with the surface within a color space using the platform interface layer, wherein the format layout indicates a layout of one or more color components of the data associated with the surface within the color space.

In another aspect, a device includes a storage device configured to store surface information and one or more processors configured to create a graphics surface via a platform interface layer. The platform interface layer lies between a client rendering API and a native platform rendering API. The one or more processors are further configured to specify a format layout of data associated with the surface within a color space using the platform interface layer and to store the format layout within the surface information of the storage device. The format layout indicates a layout of one or more color components of the data associated with the surface within the color space.

In one aspect, a computer-readable medium includes instructions for causing one or more programmable processors to create a graphics surface via a platform interface layer that lies between a client rendering API and a native platform rendering API, and to specify a format layout of data associated with the surface within a color space using the platform interface layer. The format layout indicates a layout of one or more color components of the data associated with the surface within the color space.

The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1A is a block diagram illustrating a device that may be used to implement multi-format support for surface creation, according to one aspect of the disclosure.

FIG. 1B is a block diagram illustrating a device that may be used to implement multi-format support for surface creation, according to another aspect of the disclosure.

FIG. 2A is a block diagram illustrating a device that may be used to implement multi-format support for surface creation in a YCbCr (luma, blue chroma difference, red chroma difference) color space, according to one aspect of the disclosure.

FIG. 2B is a block diagram illustrating further details of API libraries shown in FIG. 2A, according to one aspect of the disclosure.

FIG. 2C is a block diagram illustrating further details of drivers shown in FIG. 2A, according to one aspect of the disclosure.

FIG. 2D is a block diagram illustrating a device that may be used to implement multi-format support for surface creation in a YCbCr (luma, blue chroma difference, red chroma difference) color space, according to another aspect of the disclosure.

FIG. 3A is a block diagram illustrating an example of surface information for surfaces, which may include one or more YCbCr surfaces, according to one aspect of the disclosure.

FIG. 3B is a block diagram illustrating an example of overlaid surface data associated with surfaces from FIG. 3A that may be displayed on a display device, according to one aspect of the disclosure.

FIG. 4 is a flow diagram of a method that may be performed by one or more of a control processor, graphics processor, and/or display processor shown in the graphics processing system of FIG. 1A, FIG. 1B, FIG. 2A, or FIG. 2D, according to one aspect of the disclosure.

FIG. 5 is a flow diagram of another method that may be performed by one or more of a control processor, graphics processor, and/or display processor shown in the graphics processing system of FIG. 1A, FIG. 1B, FIG. 2A, or FIG. 2D, according to one aspect of the disclosure.

FIG. 6 illustrates an example in which YCbCr surface configuration/sampling information may be used to indicate configuration and sampling information for a YCbCr surface, according to one aspect of the disclosure.

### DETAILED DESCRIPTION

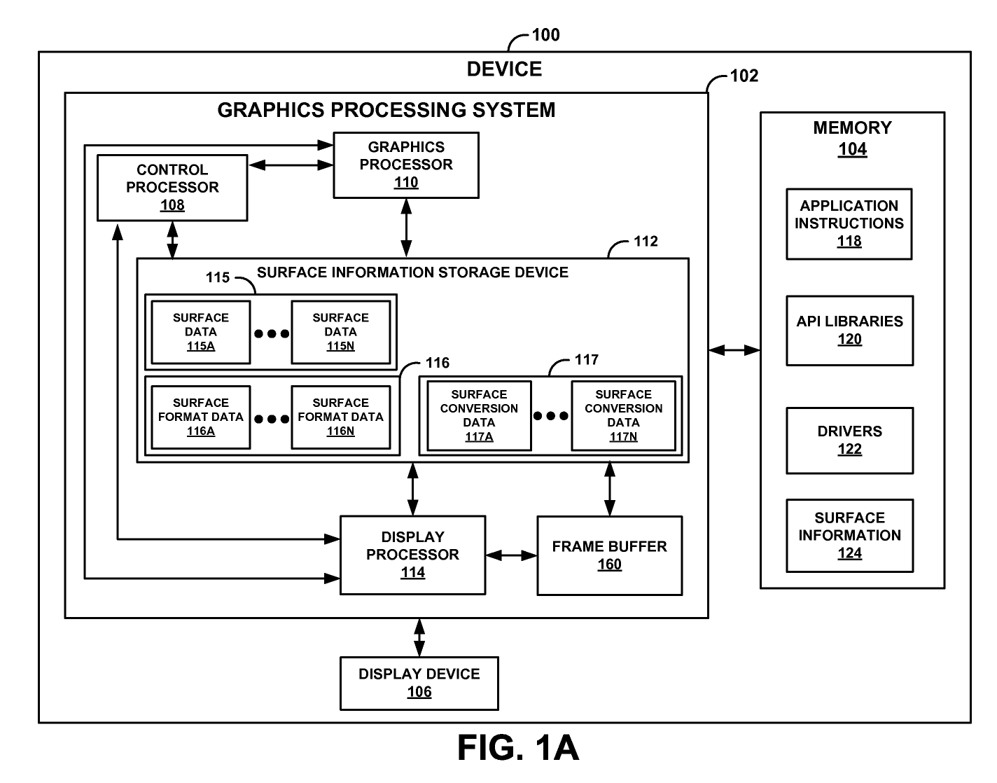

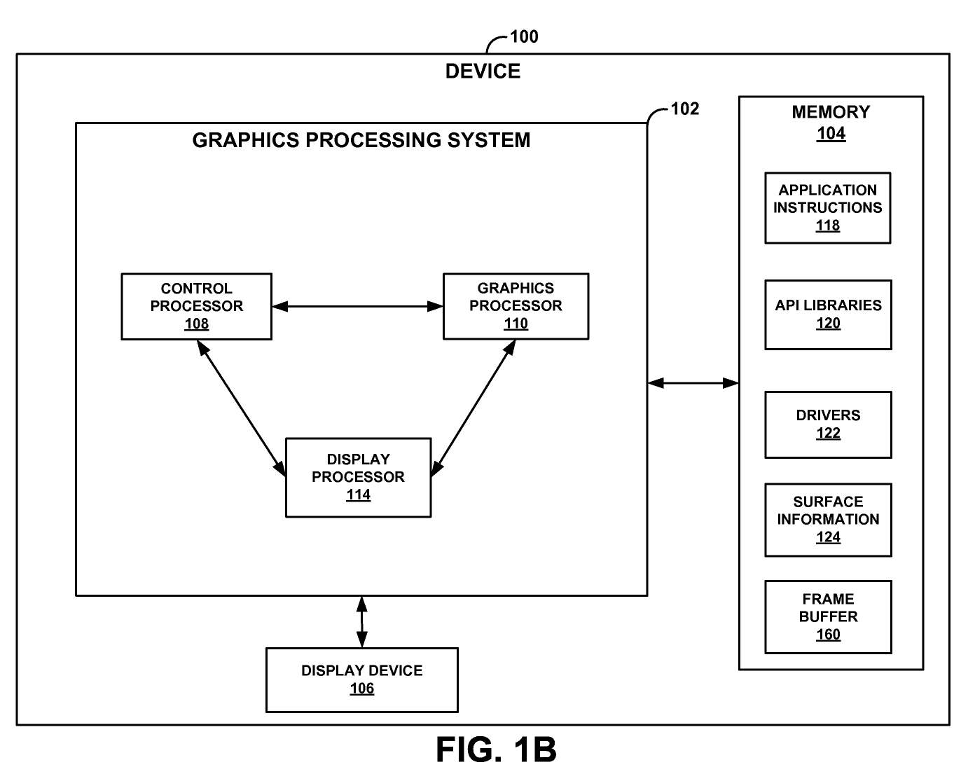

FIG. 1A is a block diagram illustrating a device 100 that may be used to implement multi-format support for surface creation, according to one aspect. Device 100 may be a stand-alone device or may be part of a larger system. For example, device 100 may comprise a wireless communication device (such as a wireless mobile handset), or may be part of a digital camera, digital multimedia player, personal digital assistant (PDA), video game console, or other video device. Device 100 may also comprise a personal computer (such as an ultra-mobile personal computer) or a laptop device. Device 100 may also be included in one or more integrated circuits, or chips, which may be used in some or all of the devices described above.

Device 100 is capable of executing various different applications, such as graphics applications, video applications, or other multi-media applications. For example, device 100 may be used for graphics applications, video game applications, video applications, digital camera applications, instant messaging applications, video teleconferencing applications, mobile applications, or video streaming applications.

Device 100 is capable of processing a variety of different data types and formats. For example, device 100 may process still image data, moving image (video) data, or other multi-media data, as will be described in more detail below. The image data may include computer-generated graphics data. Device 100 includes a graphics processing system 102, memory 104, and a display device 106. Programmable processors 108, 110, and 114 are logically included within graphics processing system 102. Programmable processor 108 may be a control, or general-purpose, processor. Programmable processor 110 is a graphics processor, and programmable processor 114 may be a display processor. Control processor 108 is capable of controlling both graphics processor 110 and display processor 114. Processors 108, 110, and 114 may be scalar or vector processors. In one aspect, device 100 may include other forms of multi-media processors.

In device 100, graphics processing system 102 is coupled both to a memory 104 and to a display device. Memory 104 may include any permanent or volatile memory that is capable of storing instructions and/or data. Display device 106 may be any device capable of displaying 3D image data, 2D image data, or video data for display purposes, such as an LCD (liquid crystal display) or plasma display, or other television (TV) display device.

Graphics processor 110 may be a dedicated graphics rendering device utilized to render, manipulate, and display computerized graphics. Graphics processor 110 may implement various complex graphics-related algorithms. For example, the complex algorithms may correspond to representations of two-dimensional or three-dimensional computerized graphics. Graphics processor 110 may implement a number of so-called “primitive” graphics operations, such as forming points, lines, and triangles or other polygon surfaces, to create complex, three-dimensional images on a display, such as display device 106.

In this disclosure, the term “render” may generally refer to 3D and/or 2D rendering. As examples, graphics processor 110 may utilize OpenGL instructions to render 3D graphics frames, or may utilize OpenVG instructions to render 2D graphics surfaces. However, any of a variety of other standards, methods, or techniques for rendering graphics may be utilized by graphics processor 110.

Graphics processor 110 may carry out instructions that are stored in memory 104. Memory 104 is capable of storing application instructions 118 for an application (such as a graphics or video application), API libraries 120, and drivers 122. Application instructions 118 may be loaded from memory 104 into graphics processing system 102 for execution. For example, one or more of control processor 108, graphics processor 110, and display processor 114 may execute one or more of instructions 118.

Control processor 108, graphics processor 110, and/or display processor 114 may also load and execute instructions contained within API libraries 120 or drivers 122 during execution of application instructions 118. Instructions 118 may refer to or otherwise invoke certain functions within API libraries 120 or drivers 122. Thus, when graphics processing system 102 executes instructions 118, it may also execute identified instructions within API libraries 120 and/or driver 122, as will be described in more detail below. Drivers 122 may include functionality that is specific to one or more of control processor 108, graphics processor 110, and display processor 114. In one aspect, application instructions 118, API libraries 120, and/or drivers 122 may be loaded into memory 104 from a storage device, such as a non-volatile data storage medium. In one aspect, application instructions 118, API libraries 120, and/or drivers 122 may comprise one or more downloadable modules that are downloaded dynamically, over the air, into memory 104.

Memory 104 further includes surface information 124. Surface information 124 may include information about surfaces that are created within graphics processing system 102. For example, surface information 124 may include surface data, surface format data, and/or surface conversion data that is associated with a given surface. This surface may comprise a 2D surface, a 3D surface, or a video surface. For the purposes of this disclosure, a 2D surface is one that may be created by a 2D API, such as, for example, OpenVG. A 3D surface is one that may be created by a 3D API, such as, for example, OpenGL. A video surface is one that may be created by a video decoder, such as, for example, H.264 or MPEG4 (Moving Picture Experts Group version 4).

Surface information 124 may be loaded into surface information storage device 112 of graphics processing system 102. Updated information within surface information storage device 112 may also be provided back for storage within surface information 124 of memory 104. In one aspect, the information contained within surface information storage device 112 may be included directly within memory 104. In this aspect, the information contained within surface information storage device 112 may be directly included within surface information 124, as is shown in FIG. 1B.

Graphics processing system 102 includes surface information storage device 112. Graphics processor 110, control processor 108, and display processor 114 each are operatively coupled to surface information storage device 112, such that each of these processors may either read data out of or write data into storage device 112. Storage device 112 is also coupled to frame buffer 160. Frame buffer 160 may be dedicated memory within graphics processing system 102. In one aspect, frame buffer 160, however, may comprise system RAM (random access memory) directly within memory 104, as is shown in FIG. 1B. Storage device 112 may be any permanent or volatile memory capable of storing data, such as, for example, synchronous dynamic random access memory (SDRAM).

Storage device 112 may include one or more surface data 115A-115N (collectively, 115), one or more surface format data 116A-116N (collectively, 116), and one or more surface conversion data 117A-117N (collectively, 117). Each surface that is created within graphics processing system 102 has associated information for that surface within surface data 115, surface format data 116, and surface conversion data 117. The surface may be a surface within one of many different color spaces, such as the RGB (red, green, blue) color space or the YCbCr (luma, blue chroma difference, red chroma difference) color space. The surface may be created by a platform interface layer, such as EGL (Embedded Graphics Library). This platform interface layer serves as an interface between a client rendering application program interface (API) and an underlying native platform rendering API, which may be included within API libraries 120.

Surface data 115 includes one or more color components (associated with a color space) and other rendering data that may be generated during surface rendering, such as by graphics processor 110. Surface data 115 may be formatted, or packed, in a predetermined or otherwise ordered fashion within storage device 112. For example, color component data for the surface may be packed using an interleaved, planar, pseudo-planar, tiled, hierarchical tiled, or other packing format within surface data 115. Surface format data 116 includes information that specifies a format layout of data included within surface data 115, as will be described in more detail below. Surface format data 116 may be specified by a platform interface layer, such as EGL. In one aspect, surface data 115 may be formatted, or packed, in a layout specified by surface format data 116.

Surface conversion data 117 provides conversion information for surfaces that are created within graphics processing system 102. In certain cases, a surface may need to be converted into a different format. For example, a YCbCr surface (i.e., a surface created within the YCbCr color space) may need to be converted into an RGB format prior to being displayed on display device 106. Display processor 114 may be capable of directly handling such conversion. In order to provide added flexibility during the conversion process, surface conversion data 117 is also provided. Graphics processing system 102, along with display processor 114, may be configured to use surface conversion data 117 to streamline the conversion process, and may allow display processor 114 to process frames of information within frame buffer 160 at a higher frame rate and/or with lower power consumption.

Each surface that is created within graphics processing system 102 has associated information within surface data 115, surface format data 116, and surface conversion data 117, according to one aspect. For example, a first created surface may have associated surface data 115A, surface format data 116A, and surface conversion data 117A. Surface data 115A may be stored in a layout specified by (or according to) surface format data 116A, and may be converted into new surface data of a different color space according to surface conversion data 117A. A second created surface may have associated surface data 115N, surface format data 116N, and surface conversion data 117N. Thus, storage device 112 is capable of storing surface information that is associated with many different surfaces within graphics processing system 102. Each created surface may have distinct format and conversion data, providing increased flexibility in the types and formats of surfaces that are used and ultimately displayed on display device 106.

In one aspect, surface format data 116A-116N may specify format layouts for surface data. For example, surface format data 116A may specify a format layout of surface data 115A. The format layout may indicate an ordering of individual color components of surface data 115A within a given color space. For example, if surface data 115A comprises RGB surface data, surface format data 116A may specify a format layout indicating an ordering of R, G, and B color components of surface data 115A. Similarly, if surface data 115A comprises YCbCr surface data, surface format data 116A may specify a format layout indicating an ordering of Y, Cb, Cr, or even possibly A (transparency) color components of surface data 115A. In the case of YCbCr data, sampling information may also be provided within surface format data 116A. Surface format data 116A may therefore provide pattern information for various different storage or packing patterns of color components within surface data 115A, such as, for example, interleaved patterns, planar patterns, pseudo-planar patterns, tiled patterns, hierarchical tiled patterns, and the like. Surface format data 116A-116N may be provided to display processor 114, such that display processor 114 may process surface data 115A-115N.

Display processor 114 is capable of reading output data from storage device 112 for multiple graphics surfaces. For any given surface, display processor 114 may read associated surface data, surface format data, and surface conversion data. For example, display processor 114 may read surface data 115A, surface format data 116A, and surface conversion data 117A that are associated with one surface. Display processor 114 may use surface format data 116A as pattern information to interpret the format, or pattern, of information that is contained within surface data 115A (which may include data in a packed form, such as, for example, an interleaved, planar, pseudo-planar, or other form). Display processor 114 may further use surface conversion data 117A to determine how to convert surface data 115A into another format, such as an RGB format.

Surface conversion data 117A may include information or values related to clamp, bias, and/or gamma, and may also include a color conversion matrix, as will be described in more detail below. Various different values may be used and configured by a user. In certain cases, values corresponding to international standards may be used as default values. International standards ITU 601 and 656 provide standard bias values and color space conversion matrices to convert between a RGB color space and other video color spaces (such as YCbCr) for standard definition television (TV). Internal standard ITU 709 provides standard bias values and color space conversion matrices to convert between a RGB color space and other video color spaces for high-definition TV.

Display processor 114 is a processor that may perform post-rendering functions on a rendered graphics frame of a surface for driving display device 106. Post-rendering functions may include scaling, rotation, blending, color-keying, and/or overlays. For example, display processor 114 may combine surfaces by using one of several blending modes, such as color keying with constant alpha blending, color-keying without constant alpha blending, full surface constant alpha blending, or full surface per-pixel alpha blending. Display processor 114 may use surface data 115, surface format data 116, and/or surface conversion data 117 when performing such post-rendering functions.

Display processor 114 can then overlay graphics surfaces onto a graphics frame in a frame buffer 160 that is to be displayed on display device 106. The level at which each graphics surface is overlaid is determined by a surface level defined for the graphics surface. This surface level may be defined by a user program, such as by application instructions 118. The surface level may be stored as a parameter associated with a rendered surface.

In one aspect, the surface level may be defined as any number, wherein the higher the number the higher on the displayed graphics frame the surface will be displayed. That is, in situations where portions of two surfaces overlap, the overlapping portions of a surface with a higher surface level will be displayed instead of the overlapping portions any surface with a lower surface level. As a simple example, the background image used on a desktop computer would have a lower surface level than the icons on the desktop. The surface levels may, in some cases, be combined with transparency information so that two surfaces that overlap may be blended together. In these cases, color keying may be used. If a pixel in a first surface does not match a key color, then the first surface can be chosen as the output pixel if alpha (transparency) blending is not enabled. If alpha blending is enabled, the pixels of the first and a second surface may be blended as usual. If the pixel of the first surface does match the key color, the pixel of the second surface is chosen and no alpha blending is performed.

In one aspect, control processor 108 may be an Advanced RISC (reduced instruction set computer) Machine (ARM) processor, such as the ARM₁₁ processor embedded in Mobile Station Modems designed by Qualcomm, Inc. of San Diego, Calif. In one aspect, display processor 114 may be a mobile display processor (MDP) also embedded in Mobile Station Modems designed by Qualcomm, Inc.

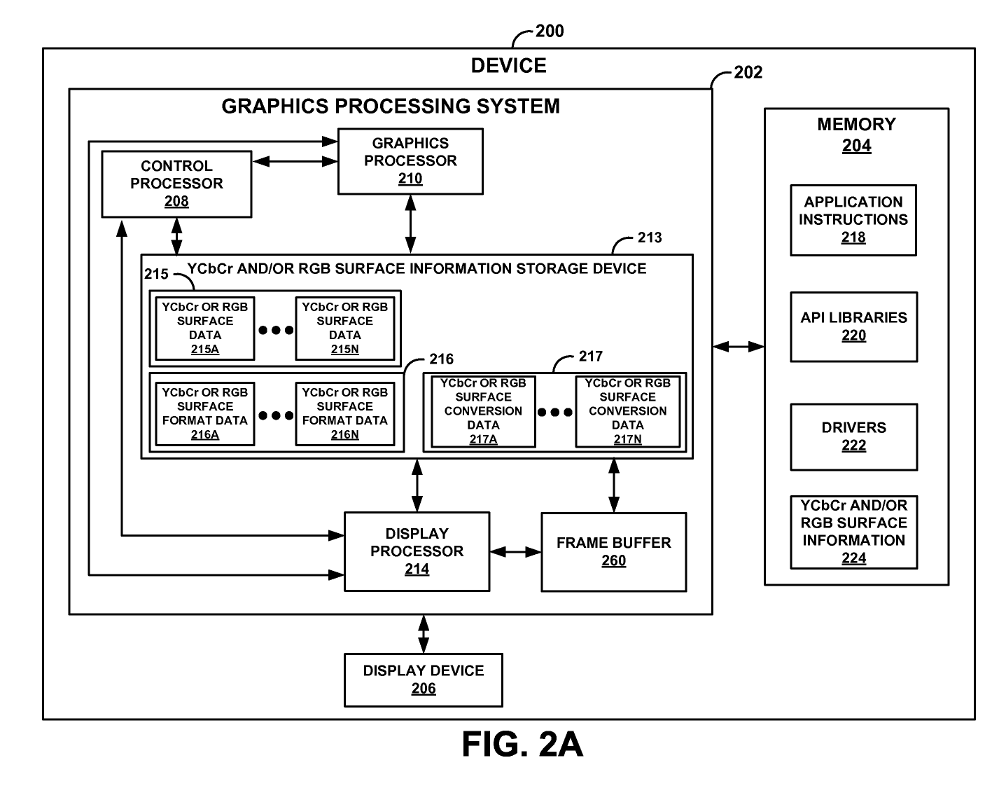

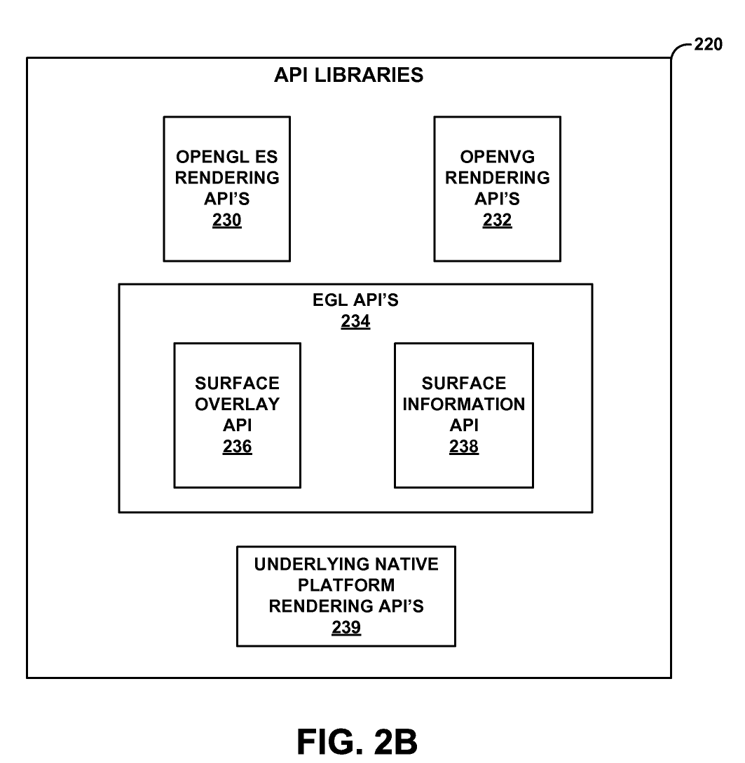

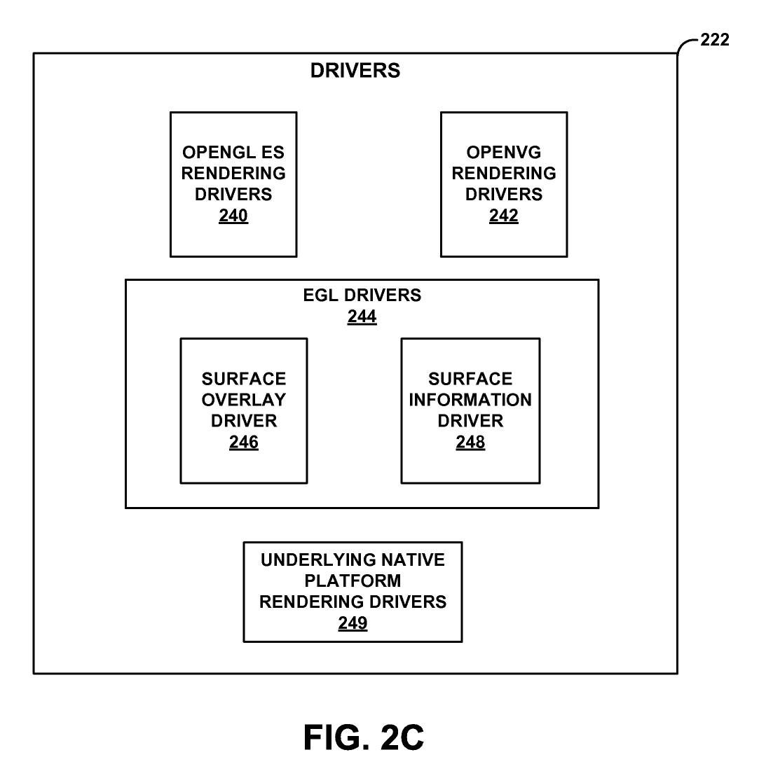

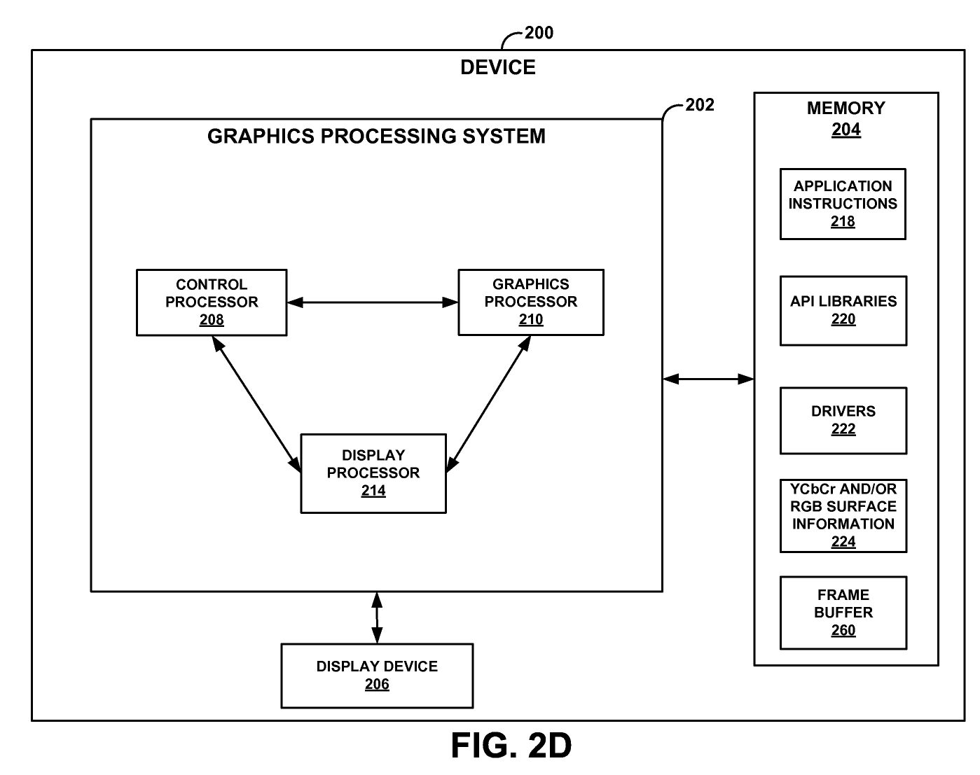

FIG. 2A is a block diagram illustrating a device 200 that may be used to implement multi-format support for surface creation in a YCbCr (luma, blue chroma difference, red chroma difference) color space and/or a RGB (red, green, blue) color space, according to one aspect. Device 200 also may support surface creation for a YCbCr surface with transparency A. In the following description, the term “YCbCr” will be used generically to refer to the YCbCr color space, wherein YCbCr surfaces may or may not include transparency data. In this aspect, device 200 shown in FIG. 2A is an example instantiation of device 100 shown in FIG. 1A. Device 200 includes a graphics processing system 202, memory 204, and a display device 206. Similar to memory 104 shown in FIG. 1A, memory 204 of FIG. 2 includes storage space for application instructions 218, API libraries 220, and drivers 222. Memory 204 also includes YCbCr and/or RGB surface information 224 for YCbCr and/or RGB surfaces that are created by graphics processing system 202. YCbCr/RGB surface information 224 may be loaded into a storage device 213 for YCbCr/RGB surface information, and updated information from storage device 213 may be stored in YCbCr/RGB surface information 224 in memory 204.

Similar to graphics processing system 102 shown in FIG. 1A, graphics processing system 202 of FIG. 2 includes a processor 208, a graphics processor 210, a display processor 214, storage device 213 for YCbCr/RGB surface information, and a frame buffer 260. Processor 208 may be a control, or general-purpose, processor. In one aspect, processor 208 may comprise a system CPU (central processing unit). Control processor 208, graphics processor 210, and display processor 214 are each operatively coupled to storage device 213, and may each write data into or read data from storage device 213. Frame buffer 260 is also coupled to storage device 213. In one aspect, storage device 213 may be included within a larger storage device, such as storage device 112 shown in FIG. 1A.

In one aspect, the information contained within surface information storage device 213 may be included directly within memory 204. In this aspect, the information contained within surface information storage device 213 may be directly included within surface information 224, as is shown in FIG. 2D. Frame buffer 260 may be dedicated memory within graphics processing system 202. In one aspect, frame buffer 260, however, may comprise system RAM (random access memory) directly within memory 204, as is shown in FIG. 2D.

Storage device 213 includes one or more YCbCr or RGB surface data 215A-215N (collectively, 215), one or more YCbCr or RGB surface format data 216A-216N (collectively, 216), and one or more YCbCr or RGB surface conversion data 217A-217N (collectively, 217). Each YCbCr or RGB surface (i.e., a surface in the YCbCr or RGB color space) that is created within graphics processing system 202 has associated information for that surface within surface data 215, surface format data 216, and surface conversion data 217. The YCbCr or RGB surface may be created by a platform interface layer, such as EGL (Embedded Graphics Library). This platform interface layer serves as an interface between a client rendering application program interface (API) and an underlying native platform rendering API, which may be included within API libraries 220.

Surface data 215 includes YCbCr and/or RGB color component and other rendering data that may be generated during surface rendering, such as by graphics processor 210. Similar to surface data 115 (FIG. 1A), surface data 215 may be formatted, or packed, in a predetermined or otherwise ordered fashion within storage device 213. Surface format data 216 includes information that specifies a format layout of data included within surface data 215, as will be described in more detail below. Surface format data 216 may be specified by a platform interface layer, such as EGL.

Surface conversion data 217 provides conversion information for surfaces that are created within graphics processing system 202 into another format prior to being displayed on display device 206. For example, surface conversion data 217 may be used to convert YCbCr surfaces into an RGB format, or may be used to convert RGB surfaces into a YCbCr format. In order to provide added flexibility during the conversion process, surface conversion data 217 is provided. Graphics processing system 202, along with display processor 214, may be able to use surface conversion data 217 to streamline the conversion process, and may allow display processor 214 to process frames of information within frame buffer 260 at a higher frame rate and/or with lower power consumption.

FIG. 2B is a block diagram illustrating further details of API libraries 220 shown in FIG. 2A, according to one aspect. As described previously with reference to FIG. 2A, API libraries 220 may be stored in memory 204 and linked, or referenced, by application instructions 218 during application execution by graphics processor 210, control processor 208, and/or display processor 214. FIG. 2C is a block diagram illustrating further details of drivers 222 shown in FIG. 2A, according to one aspect. Drivers 222 may be stored in memory 204 and linked, or referenced, by application instructions 218 and/or API libraries 220 during application execution by graphics processor 210, control processor 208, and/or display processor 214.

In FIG. 2B, API libraries 220 include OpenGL ES rendering API's 230, OpenVG rendering API's 232, EGL API's 234, and underlying native platform rendering API's 239. Drivers 222, shown in FIG. 2C, includes OpenGL ES rendering drivers 240, OpenVG rendering drivers 242, EGL drivers 244, and underlying native platform rendering drivers 249. OpenGL ES rendering API's 230 are API's invoked by application instructions 218 during application execution by graphics processing system 202 to provide rendering functions supported by OpenGL ES, such as 2D and 3D rendering functions. OpenGL ES rendering drivers 240 are invoked by application instructions 218 and/or OpenGL ES rendering API's 230 during application execution for low-level driver support of OpenGL ES rendering functions in graphics processing system 202.

OpenVG rendering API's 232 are API's invoked by application instructions 218 during application execution to provide rendering functions supported by OpenVG, such as 2D vector graphics rendering functions. OpenVG rendering drivers 242 are invoked by application instructions 218 and/or OpenVG rendering API's 232 during application execution for low-level driver support of OpenVG rendering functions in graphics processing system 202.

EGL API's 234 (FIG. 2B) and EGL drivers 244 (FIG. 2C) provide support for EGL functions in graphics processing system 202. In one aspect, EGL extensions may be incorporated within EGL API's 234 and EGL drivers 244. In the examples of FIGS. 2B-2C, EGL extensions for surface overlay and surface information functionality (such as, for example, YCbCr surface information functionality) are provided. Thus, for the EGL surface overlay extension, a surface overlay API 236 is included within EGL API's 234 and a surface overlay driver 246 is included within EGL drivers 244. Likewise, for the EGL surface information extension, a surface information API 238 (which may include, for example, a YCbCr surface information API) is included within EGL API's 234 and a surface information driver 248 is included within EGL drivers 244.

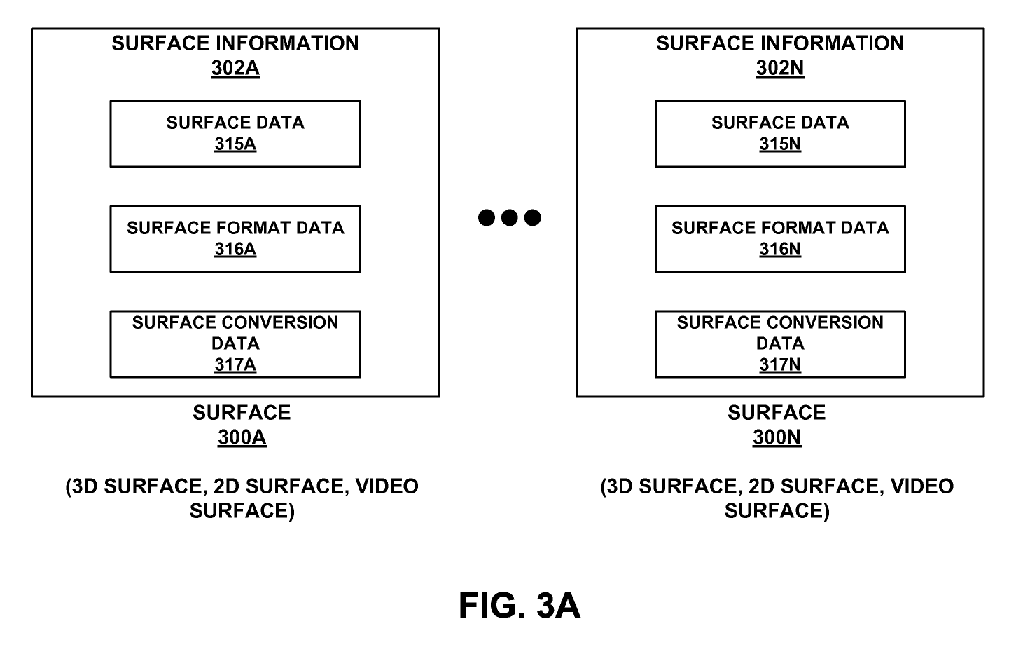

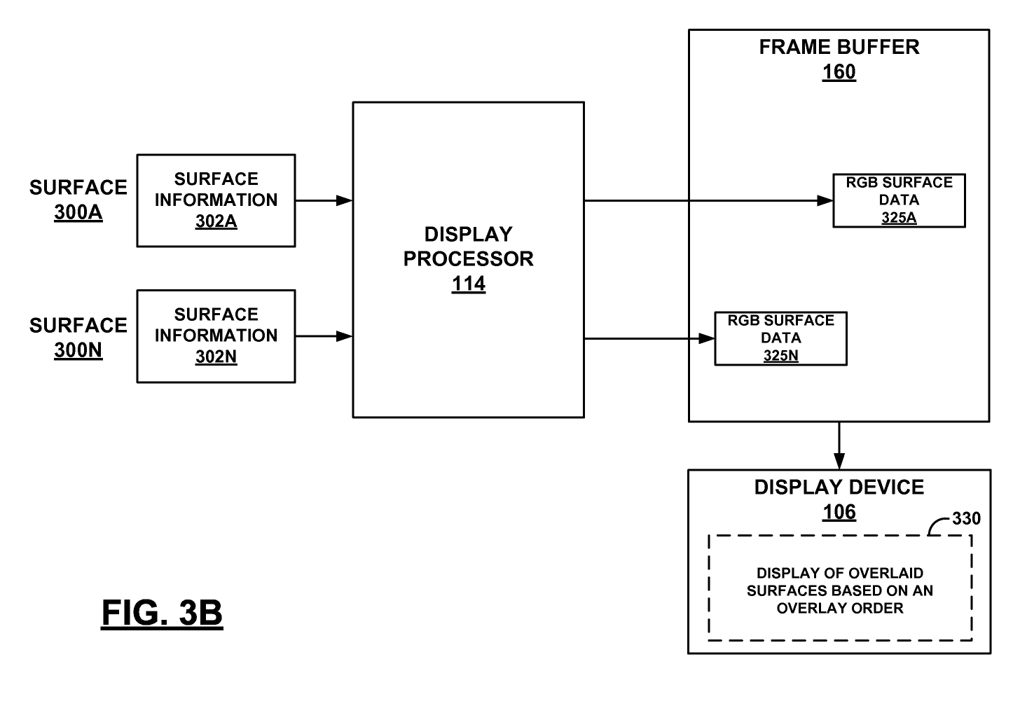

The EGL surface overlay extension provides a surface overlay stack for overlay of multiple graphics surfaces (such as 2D surfaces, 3D surfaces, and/or video surfaces) that are displayed on display device 206. The graphics surfaces may each have an associated surface level within the stack. The overlay of surfaces is thereby achieved according to an overlay order of the surfaces within the stack. An examples of a surface overlay is shown in FIG. 3B and will be discussed in more detail below.

In one aspect, the EGL surface information extension provides multi-format support for surface creation within graphics processing system 202, and may particularly provide support for YCbCr surfaces. As previously described, storage device 213 contains surface data 215 (which may include YCbCr surface data), surface format data 216 (which may include format data for YCbCr surfaces), and surface conversion data 217 (which may include data to convert YCbCr surfaces into an RGB format). The EGL surface information extension provides support for data flow into and out of storage device 213, and provides information that may be needed by one or more of control processor 208, graphics processor 210, and/or display processor 214 during surface rendering, data conversion (such as YCbCr-to-RGB conversion), and display of surfaces within graphics processing system 202.

As is shown in FIG. 2B, API libraries 220 also includes underlying native platform rendering API's 239. API's 239 are those API's provided by the underlying native platform implemented by device 200 during execution of application instructions 218. EGL API's 234 provide a platform interface layer between underlying native platform rendering API's 239 and both OpenGL ES rendering API's 230 and OpenVG rendering API's 232. As is shown in FIG. 2C, drivers 222 includes underlying native platform rendering drivers 249. Drivers 249 are those drivers provided by the underlying native platform implemented by device 200 during execution of application instructions 218 and/or API libraries 220. EGL drivers 244 may provide a platform interface layer between underlying native platform rendering drivers 249 and both OpenGL ES rendering drivers 240 and OpenVG rendering drivers 242.

FIG. 3A is a block diagram illustrating an example of surface information for surfaces, which may include one or more YCbCr or RGB surfaces, according to one aspect. In FIG. 3A, surfaces 300A-300N are represented. Each surface 300A-300N is a surface that may be processed by graphics processing system 102 and ultimately displayed on display device 106 shown in FIG. 1A or FIG. 1B, for example. These surfaces 300A-300N may also be processed by graphics processing system 202 shown in FIG. 2A or FIG. 2D. However, for purposes of illustration only in the following description of FIGS. 3A-3B, it will be assumed that surfaces 300A-300N are processed by graphics processing system 102.

Each surface 300A-300N may comprise a 2D surface, a 3D surface, or a video surface that may be represented in a given color space, such as an RGB or a YCbCr color space. Within each frame of data captured within frame buffer 160 and displayed on display device 106, surfaces 300A-300N may be overlaid according to an overlay order. An example of this is shown in FIG. 3B. In such fashion, 2D surfaces, 3D surfaces, and/or video surfaces in various different color spaces, including the RGB and YCbCr color spaces, may be overlaid in a surface overlay stack and displayed together on display device 106.

Each surface 300A-300N is associated with corresponding surface information. For example, in FIG. 3A, surface 300A is associated with surface information 302A, while surface 300N is associated with surface information 302N. Surface information 302A-302N may be stored within storage device 112.

Surface information 302A includes surface data 315A, surface format data 316A, and surface conversion data 317A. Similarly, surface information 302N includes surface data 315N, surface format data 316N, and surface conversion data 317N. In one aspect, surface data 315A-315N are similar to surface data 115A-115N, surface format data 316A-316N are similar to surface format data 116A-116N, and surface conversion data 317A-317N are similar to surface conversion data 117A-117N. Thus, each surface 300A-300N has associated surface data (such as rendering data, which may be stored in a packed format), surface format data to specify the format of the surface data, and surface conversion data to specify, if necessary, conversion information of the surface data (such as, for example, YCbCr surface data) into an RGB format, such that it may be processed by display processor 114 and displayed on display device 106.

FIG. 3B is a block diagram illustrating an example of overlaid surface data associated with surfaces 300A and 300N from FIG. 3A that may be displayed on display device 106, according to one aspect. One or more of surfaces 300A-300N may comprise YCbCr surfaces. Surface 300A has associated surface information 302A, and surface 300N has associated surface information 302N. Surface information 302A and 302N may be stored within storage device 112.

In the example of FIG. 3B, it is assumed that display processor 114 reads surface information 302A for surface 300A out of storage device 112. Display processor 114 may then obtain surface data 315A and process such data using surface format data 316A and surface conversion data 317A. Display processor 114 uses surface format data 316A to interpret the format of packed layout of surface data 315A when processing such data. In addition, display processor 114 uses surface conversion data 317A to assist in the conversion of surface data 315A into RGB surface data 325A (i.e., into an RGB format), if necessary, which may then be written to frame buffer 160. (In this example, it is assumed that display device 106 is an LCD device. Of course, in other scenarios, display device 106 may comprise other forms of display devices, such as a TV device.)

Similarly, display processor 114 may read surface information 302N for surface 300N and generate RGB surface data 325N from surface data 315N by using surface format data 316N and surface conversion data 317N. Display processor 114 may then write RGB surface data 325N into frame buffer 160. In this manner, RGB surface data 325A and 325N may be included within one frame of data to be displayed on display device 106.

In one aspect, RGB surface data 325A and 325N may be included within a surface overlay stack. In this aspect, display processor 114 may associate each of RGB surface data 325A and 325N with a distinct surface level within the stack, thereby implementing an overlay order for RGB surface data 325A and 325N. RGB surface data 325A is associated with one frame of surface data for surface 300A, and RGB surface data 325N is associated with one frame of surface data for surface 300N.

In one aspect, the levels of surfaces 300A and 300N, or the sequence in which they are bound to a particular level, may both be taken into account during the surface overlay process. In certain cases, multiple surfaces may be bound to a particular layer. Layers may be processed by from back to front (most negative to most positive). Within a given layer, surfaces are processed in the sequence which they were bound to the layer.

in FIG. 3B, RGB surface data 325A and 325N may be displayed on display device 106 within a screen area 330 that is visible to a user. RGB surface data 325A and 325N may be displayed within screen area 330 as overlaid surfaces based upon the overlay order used by display processor 114. RGB surface data 325A and 325N may or may not be displayed with the same position or relationship as included within frame buffer 160. Display processor 114 may use a surface overlay stack to assign any surface overlay levels for display of the surfaces on display device 106. As a result, graphics processing system 102 may be capable of providing 2D, 3D, and/or video surface data that may be overlaid for display to a user on display device 206. For example, if surface 300A is an RGB 3D surface in the example of FIG. 3B, and surface 300N is a YCbCr video surface, 3D and video surface data associated with these surfaces may be displayed on display device 106 (wherein the YCbCr video surface data is converted into an RGB format prior to being displayed). In some aspects, any combination of 2D, 3D, and/or video surface data, having any defined surface format for one or more color spaces, may be overlaid on display device 106.

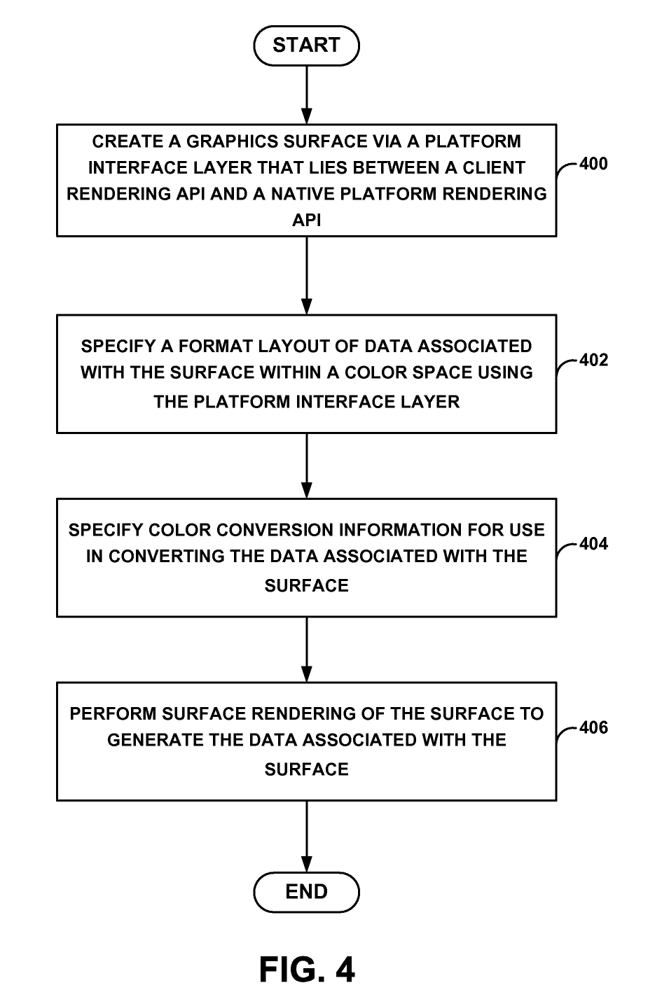

FIG. 4 is a flow diagram of a method that may be performed by one or more of control processor 108, graphics processor 110, and/or display processor 114 shown in graphics processing system 102 of FIG. 1A or FIG. 1B, or by one or more of control processor 208, graphics processor 210, and/or display processor 214 shown in graphics processing system 202 of FIG. 2A or FIG. 2D, according to one aspect. For purposes of illustration only in the description below, it will be assumed that the method shown in FIG. 4 is performed by one or more processors in graphics processing system 102.

Initially, one or more of control processor 108, graphics processor 110, and/or display processor 114 creates a graphics surface via a platform interface layer, such as EGL (400 in FIG. 4). The platform interface layer serves as an interface and lies between a client rendering API, such as OpenGL ES or OpenVG, and an underlying native platform rendering API. If the color space comprises a YCbCr color space, the surface may be a YCbCr surface. If the color space comprises an RGB color space, the surface may be an RGB surface.

One or more of control processor 108, graphics processor 110, and/or display processor 114 then may specify (402 in FIG. 4) a format layout of surface data associated with the surface within the color space using the platform interface layer. The format layout indicates a layout, such as an ordering, of one or more color components of the surface data within the color space. For example, if the surface is a YCbCr surface, the format layout may indicate an ordering of individual Y, Cb, Cr, and possibly A (transparency) color components of the surface data. If the surface is an RGB surface, the format layout may indicate an ordering of individual R, G, and B color components of the surface data. Both the surface data and the format layout (format data) may be stored, such as in storage device 112. The format layout of the surface data may also be provided as pattern information for purposes of displaying the surface on a display device, such as display device 106.

In one aspect, the format layout may indicate a first layout of a first group of the one or more color components within a first plane. The format layout may further indicate a second layout of a second group of the one or more color components within a second plane that is different from the first plane. The first group may include a plurality of the one or more color components, and the first layout may indicate an ordering of the color components of the first group within the first plane. In various different scenarios, any number of format layouts may be specified within any number of different planes.

Referring again to FIG. 4, at 404, one or more of the processors may specify color conversion information for use in converting the surface data associated with the surface into converted data within a different color space. For example, if the color space is a YCbCr color space, and the different color space is an RGB color space, the color conversion information may be used to convert YCbCr surface data into RGB surface data.

At 406, one or more processors may perform surface rendering of the surface to generate the surface data. This surface data may then be stored according to the specified format layout.

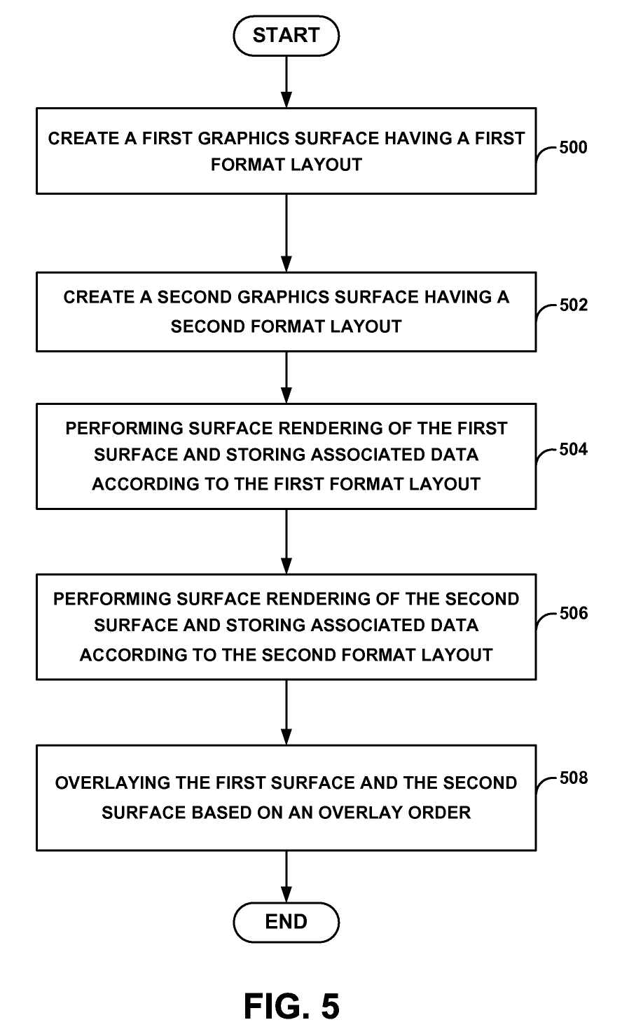

FIG. 5 is a flow diagram of a method that may be performed by one or more of control processor 108, graphics processor 110, and/or display processor 114 shown in graphics processing system 102 of FIG. 1A or FIG. 1B, or by one or more of control processor 208, graphics processor 210, and/or display processor 214 shown in graphics processing system 202 of FIG. 2A or FIG. 2D, according to one aspect. For purposes of illustration only in the description below, it will be assumed that the method shown in FIG. 5 is performed by one or more processors in graphics processing system 102.

Initially, one or more of control processor 108, graphics processor 110, and/or display processor 114 creates a first graphics surface having a first format layout (500) and a second graphics surface having a second format layout (502). The first and second surfaces may, in some cases, each comprise a 2D surface, a 3D surface, or a video surface. One or more of the processors then performs surface rendering of the first surface and stores associated surface data in a storage device, such as storage device 112, according to the first format layout (504). At 506, surface rendering of the second surface is performed, and associated surface data is stored according to the second format layout. At 508, one or more of the processors overlays the first surface and the second surface based on an overlay order. In such fashion, surface data associated with multiple surfaces may be read out of storage device 112 by display processor 114 into a surface overlay stack and provided for display on display device 106 according to the overlay order.

As discussed previously, multi-format support for surface creation and use may be implemented by one or more processors within system 102 and/or system 202 (FIG. 2A). In one aspect, functionality to implement multi-format support for surface creation and use, when executed by one or more processors, may be included within API libraries 120 and/or drivers 122, or within API libraries 220 and/or drivers 222 (FIG. 2A). For example, such functionality may be included within surface information API 238 (FIG. 2B) and/or within surface information driver 248 (FIG. 2C). In one aspect, this functionality may be provided as part of a platform interface layer extension, such as an EGL extension. For purposes of illustration only in the description below, it will be assumed that such functionality is provided as part of an EGL extension (i.e., an extension to the EGL specification).

In one aspect, an EGL extension is provided for exporting of configurations that can support various forms of YCbCr formats. In addition to just the configuration changes, the extension may also define a mechanism to further specify the format layout of the YCbCr data as well as the information required for color format conversion to RGB if that surface is later posted to display device 106.

In some cases, display device 106 may be a TV display device rather than an LCD. In this case, RGB surfaces may be converted to YCbCr surfaces when surfaces within an overlay stack are processed.

Within the EGL extension of this aspect, additional YCbCr format data may be applicable to configurations where the EGL_{—}COLOR_{—}BUFFER_{—}TYPE field of EGL is set to EGL_{—}LUMINANCE_{—}BUFFER. In this case, the EGL_{—}SAMPLES field is used to indicate the sampling ratio for the YCbCr surface.

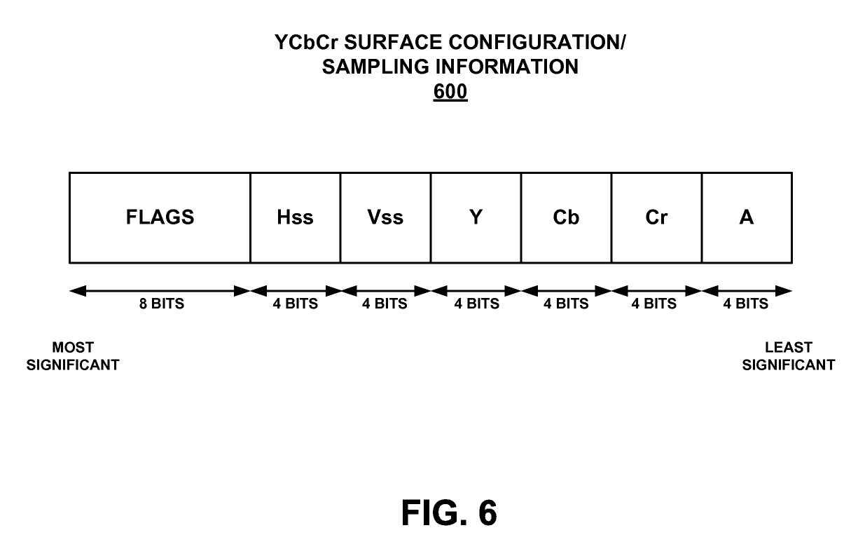

FIG. 6 illustrates an example of such a case in which YCbCr surface sampling configuration information 600 is used to indicate configuration and sampling information for a YCbCr surface, according to one aspect. In this aspect, YCbCr surface sampling configuration information 600 comprises information for the EGL_{—}SAMPLES field. The most significant byte (eight bits), as shown in FIG. 6, is used for flags. EGL_{—}YCBCR_{—}ENABLE, EGL_{—}CBCR_{—}COSITE, and EGL_{—}CBCR_{—}OFFSITE are flags, or tokens, that may be used.

The next two nibbles (wherein one nibble comprises four bits) define horizontal and vertical sub-sampling factors, respectively. The lower (i.e., least significant) four nibbles define the luminance (Y), blue chroma difference (Cb), red chroma difference (Cr), and alpha (A) transparency sampling factors, respectively. In one aspect, the EGL_{—}YCBCR_{—}ENABLE flag, or token, can be used to differentiate a YCbCr surface from a multi-sampled luma or luma-alpha surface.

In one aspect, the EGL extension may provide four new functions related to YCbCr surface format and conversion processing (including “set” and “get” functions), which will be described in more detail below. Example function declarations for these four functions are shown below:

```
EGLBoolean eglSurfaceYCbCrFormatQUALCOMM( EGLDisplay dpy,
                EGLSurface surf,
                const EGLYCbCrFormat *format );
EGLBoolean eglGetSurfaceYCbCrFormatQUALCOMM( EGLDisplay
                  dpy, EGLSurface surf,
                  EGLYCbCrFormat *format );
EGLBoolean eglSurfaceYCbCrConversionQUALCOMM( EGLDisplay
                    dpy, EGLSurface surf,
                    const EGLYCbCrConversion *conv );
EGLBoolean eglGetSurfaceYCbCrConversionQUALCOMM( EGLDisplay
                      dpy, EGLSurface surf,
                      EGLYCbCrConversion *conv );
```

The eglSurfaceYCbCrFormatQUALCOMM function sets the YCbCr format for an EGL YCbCr surface. The eglGetSurfaceYCbCrFormatQUALCOMM function gets, or returns, YCbCr format data for an EGL YCbCr surface. The eglSurfaceYCbCrConversionQUALCOMM function sets various conversion parameters that may be used to convert an EGL YCbCr surface to another color space, such as to an RGB color space. The eglGetSurfaceYCbCrConversionQUALCOMM function gets, or returns, the various conversion parameters. Various aspects of these functions are described in more detail below.

In one aspect, the EGL extension provides additional, new data type structures. These structures relate to the format of YCbCr surface data, as well as conversion information. Example data structures are shown below:

| typedef struct | |
|---|---|
| { | |
| EGLint | order[2]; |
| void | *offset; |

| } EGLYCbCrPlaneFormat; | |
|---|---|
| typedef struct | |
| { | |
| EGLYCbCrPlaneFormat plane[4]; | |
| } EGLYCbCrFormat; | |
| typedef EGLint EGLfixed; | |
| typedef struct | |
| { | |
| EGLint | clamp_min[3]; |
| EGLint | clamp_max[3]; |
| EGLint | bias[3]; |
| EGLfixed | csc_matrix[9]; |
| EGLfixed | gamma; |

} EGLYCbCrConversion;

The EGL EGLSurface data structure may contain two additional members of type EGLYCbCrFormat and EGLYCbCrConversion for a YCbCr surface. The EGLYCbCrFormat member provides formatting information for the YCbCr surface, and the EGLYCbCrConversion member provides color conversion information for the YCbCr surface, as is described in more detail below.

In one aspect, the EGL extension provides additional tokens. These tokens are described in more detail below, and are represented in hexadecimal form. These new tokens are as follows:

| | |
|---|---|
| EGL_CBCR_OFFSITE | 0x00000000 |
| EGL_CBCR_COSITE | 0x01000000 |
| EGL_YCBCR_ENABLE | 0x80000000 |
| EGL_Y_BIT | 0x00000001 |
| EGL_CR_BIT | 0x00000002 |
| EGL_CB_BIT | 0x00000004 |
| EGL_ALPHA_BIT | 0x00000008 |

The EGL_{—}YCBCR_{—}ENABLE flag, or token, can be used to differentiate a YCbCr surface from a multi-sampled luma or luma-alpha surface. The chroma samples may either co-site (co-located) with the luma samples or interpolated (off-site). The co-site token EGL_{—}CBCR_{—}COSITE or the off-site token EGL_{—}CBCR₁₃ OFFSITE may be logically or'ed with the EGL_{—}YCBCR_{—}ENABLE token and the other nibbles specific to a value for EGL_{—}SAMPLES that matches the desired format.

To set a particular YCbCr format for a new YCbCr surface, the function eglSurfaceYCbCrFormatQUALCOMM may be called with an EGLYCbCrFormat data structure that defines an exact layout of the YCbCr data. Each element of the plane array within the data structure represents a plane of potentially interleaved color components. The order variable of the EGLYCbCrPlaneFormat structure has each nibble set to either EGL_{—}Y_{—}BIT, EGL_{—}CR_{—}BIT, EGL_{—}CB_{—}BIT, or EGL_{—}ALPHA_{—}BIT to represent the ordering of components in that plane. (Although the order variable is shown in the example structure as an array of two EGLint's, which may be unsigned, various other types and array sizes may be used.) The EGLYCbCrFormat structure defines four different planes, but any number of planes could be used. The order variable may be filled out starting from the zero-ith element's most significant nibble. Once a nibble with value zero is found, the pattern is assumed to repeat and no further nibbles are examined, according to one aspect. If a particular format is not supported by an implementation, EGL_{—}FALSE may be returned with no error set. An application may call eglGetSurfaceYCbCrFormatQUALCOMM to determine the format currently in use for a surface.

To set a particular YCbCr color conversion, the function eglSurfaceYCbCrConversionQUALCOMM may be called with an EGLYCbCrConversion data structure that defines the clamp, bias, color conversion matrix and gamma values to use when posting the surface to a display device. An application may call eglGetSurfaceYCbCrConversionQUALCOMM to determine the parameters (such as the clamp, bias, color conversion matrix and gamma parameters) currently in use. The colorspace conversion matrix may use a fixed-point format and may be stored in row major format. (The EGLfixed type may be a 32-bit EGLint that may be interpreted as having S15.16 format.) In certain cases, values corresponding to international standards may be used as default values, and a default gamma value of 2.22 may be used. International standards ITU 601 and 656 provide standard bias values and color space conversion matrices to convert between a RGB color space and other video color spaces (such as YCbCr) for standard definition TV. Internal standard ITU 709 provides standard bias values and color space conversion matrices to convert between a RGB color space and other video color spaces for high-definition TV. However, an application and application developer may have full flexibility to utilize any values for the clamp, bias, color conversion matrix and gamma parameters to customize the conversion of a YCbCr or other color space surface into an RGB format.

To provide an example of an implementation of an EGL extension that supports multi-format and conversion capabilities of EGL YCbCr surfaces, the following sample code is provided, which utilizes several of the functions, structures, and tokens listed above for purpose of illustration:

```
// Construct a matching config for a YCbCr surface
const EGLint attribs[3] =
{
    EGL_SAMPLES, EGL_YCBCR_ENABLE,
    EGL_NONE
}
// Get list of all matching configs
eglChooseConfig( dpy, attribs, &configs, configs_size, &num_configs );
// Choose which YCbCr surface available matches our format
// This is done by querying each returned config for the EGL_SAMPLES
// field and looking for the correct signature.
// For 4:2:2:4 (H2V1) cosite, the signature would be: 0x81214224.
// For the sake of this example, assume a 4:2:2:4 (H2V1) format
// was chosen and assigned to a variable ‘cfg’.
// Create a pixmap with this format
// be sure to check pix != EGL_NO_SURFACE
// YCbCrASurface is the native pixmap surface/type handle
pix = eglCreatePixmapSurface( dpy, cfg, YCbCrASurface, NULL );
// Setup the format packing order, in this case an interleaved plane
// of YCbCr and a separate plane of Alpha.
const EGLYCbCrFormat fmt =
{
  // Plane 0
  {
    {
    EGL_Y_BIT << 28 | EGL_CB_BIT << 24 |
    EGL_Y_BIT << 20 | EGL_CR_BIT << 16,
    0
  },
  YCbCrOffset
  },
  // Plane 1
  {
  {
    EGL_ALPHA_BIT << 28,
    0
  },
  AOffset
  },
  // Plane 2
  {
  {
    0,
    0
  },
  (void*)0
  },
  // Plane 3
  {
  {
    0,
    0
  },
  (void*)0
  }
};
// Set the format.
// This will return EGL_FALSE if the format is not supported on the
// platform.
eglSurfaceYCbCrFormatQUALCOMM( dpy, pix, &fmt );
// Now the surface can be used like any other EGL surface; for
// example, using an external decoder to render video to the pixmap
// then using a surface overlay extension to composite
// the video frame into an EGL application
```

In the sample code above, a list of attributes is first set up, using the EGL_{—}YCBCR_{—}ENABLE flag with EGL_{—}SAMPLES. Next, a list of all matching configurations is obtained. It is assumed in the sample code that an available YCbCr surface is chosen that matches the format set up for EGL_{—}SAMPLES. This may be done by querying each return configuration for the EGL_{—}SAMPLES field and looking for the correct signature. In the sample code, it is assumed that a 4:2:2:4 (H2V1) format was chosen and assigned to a variable cfg. For this example sampling format, the signature for EGL_{—}SAMPLES could be 0x81214224, in hexadecimal, for the format shown in FIG. 6. In this case, the EGL_{—}YCBCR_{—}ENABLE and EGL_{—}CBCR_{—}COSITE bits are set, Hss (horizontal sub-sampling) is equal to two (i.e., chroma is sampled every other pixel in the horizontal direction), Vss (vertical sub-sampling) is equal to one (i.e., chroma is sampled every pixel in the vertical direction), luma sampling is equal to four out of four, blue chroma difference sampling is equal to two out of four, red chroma difference sampling is equal to two out of four, and alpha sampling is equal to four out of four.

Next, in the sample code, a pixmap (off-screen) surface is created with this format. The pixmap surface is a YCbCr surface using A, or Alpha (transparency). Of course, other forms of surfaces may be created.

Next, the format packing order for the surface data is set up using an interleaved plane of YCbCr data and a separate plane of Alpha. To do so, a variable fmt of type EGLYCbCrFormat is initialized. Only planes zero and one are populated with format data in this example. Of course, in other examples, one or more of the planes may be populated with format data. In addition, any type of pattern of color components may be defined within each plane, such as an interleaved pattern, a planar pattern, a pseudo-planar pattern, tiled pattern, hierarchical tiled pattern, or other form of packing pattern. Further, in some aspects, other color space formats, such as formats for RGB surface data, may be defined in a similar fashion using similar data structures to EGLYCbCrFormat to set up the format packing order for the R, G, and B color components.

Referring again to the sample code, plane zero includes format data for the group of the Y, Cb, and Cr components. With this definition in plane zero, an interleaved pattern, or ordering, of Y, Cb, and Cr components is defined using the EGL_{—}Y_{—}BIT, EGL_{—}CB_{—}BIT, EGL_{—}Y_{—}BIT, and EGL_{—}CR_{—}BIT for the order variable, assuming in this example that a 4:2:2:4 (H2V1) format is used. A value of zero is then provided within the order variable to indicate that the pattern repeats. The offset pointer YCbCrOffset is used as an offset pointer directly to plane zero for reference, given that the plane may be arbitrarily stored in memory. Typically, YCbCrOffset will be zero, but it is not necessarily the case.

Plane one includes format data for Alpha (transparency). Only the EGL_{—}ALPHA_{—}BIT is used for setting up the format in this plane. The offset pointer AOffset is used as an offset pointer directly to plane one for reference. Typically, AOffset will not be zero, but it is not necessarily the case.

Finally, in the sample code, the surface format is set up by invoking the eglSurfaceYCbCrFormatQUALCOMM function. At this point, the surface may be used like any other EGL surface. The surface may comprise a 2D, a 3D, or a video surface, and it may be combined with one or more additional surfaces within a surface overlay stack to composite a frame of data within a frame buffer, such as frame buffer 160 (FIG. 1A or FIG. 1B), for display on a display device, such as display device 106. EGL may provide a mechanism to denote which API's are supported for a particular surface via a field in the EGLConfig structure.

The various components illustrated in FIGS. 1-5 may be realized by any suitable combination of hardware and/or software. In FIGS. 1-5, various components are depicted as separate units or modules. However, all or several of the various components described with reference to FIGS. 1A-5 may be integrated into combined units or modules within common hardware and/or software. Accordingly, the representation of features as components, units or modules is intended to highlight particular functional features for ease of illustration, and does not necessarily require realization of such features by separate hardware or software components. In some cases, various units may be implemented as programmable processes performed by one or more processors.

For example, various aspects of the techniques described in this disclosure may be implemented within one or more general purpose microprocessors, digital signal processors (DSPs), application specific integrated circuits (ASICs), field programmable gate arrays (FPGAs), or other equivalent logic devices. Accordingly, the terms “processor” or “controller,” as used herein, may refer to any of the foregoing structures or any other structure suitable for implementation of the techniques described herein.

The components and techniques described herein may be implemented in hardware, software, firmware, or any combination thereof. Any features described as modules or components may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices, and may be used in any of a variety of image, display, audio, or other multi-media applications and devices. In some aspects, for example, such components may form part of a mobile device, such as a wireless communication device handset.

If implemented in software, the techniques may be realized at least in part by a computer-readable medium comprising instructions or code that, when executed by one or more processors, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), eDRAM (embedded Dynamic Random Access Memory), static random access memory (SRAM), FLASH memory, magnetic or optical data storage media.

The techniques additionally, or alternatively, may be realized at least in part by a computer-readable communication medium that carries or communicates code in the form of instructions or data structures and that can be accessed, read, and/or executed by one or more processors. Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Any software that is utilized may be executed by one or more processors, such as one or more DSP's, general purpose microprocessors, ASIC's, FPGA's, or other equivalent integrated or discrete logic circuitry.

Various aspects of the disclosure have been described. These and other aspects are within the scope of the following claims.

1. A method comprising:
creating a graphics surface via a platform interface layer that lies between a client rendering application program interface (API) and a native platform rendering API; and
specifying a format layout of data associated with the surface within a color space using the platform interface layer, wherein the format layout indicates a layout of one or more color components of the data within the color space.

2. The method of claim 1, wherein:
the platform interface layer comprises an embedded graphics library (EGL) layer; and
the client rendering API comprises an Open Graphics Library (OpenGL) API or an Open Vector Graphics (OpenVG) API.

3. The method of claim 1, wherein:
the color space comprises a luma, blue chroma difference, red chroma difference (YCbCr) color space;
the surface comprises a YCbCr surface; and
the format layout indicates the ordering of individual Y, Cb, and Cr components of the data.

4. The method of claim 1, wherein the format layout indicates a first layout of a first group of the one or more color components within a first plane, and wherein the format layout further indicates a second layout of a second group of the one or more color components within a second plane that is different from the first plane.

5. The method of claim 4, wherein the first group includes a plurality of the one or more color components, and wherein the first layout indicates an ordering of the plurality of color components of the first group within the first plane.

6. The method of claim 1, further comprising:
storing the data associated with the surface; and
storing the format layout of the data as format data.

7. The method of claim 1, further comprising:
providing the format layout of the data associated with the surface as pattern information to a processor for purposes of displaying the surface on a display device.

8. The method of claim 1, further comprising:
specifying color conversion information for use in converting the data associated with the surface into converted data within a different color space.

9. The method of claim 8, wherein:
the color space comprises a luma, blue chroma difference, red chroma difference (YCbCr) color space;
the different color space comprises a red, green, blue (RGB) color space; and
the converted data comprises RGB surface data.

10. The method of claim 1, further comprising:
creating a second surface within the color space using the platform interface layer;
specifying a second format layout of second data associated with the second surface within the color space using the platform interface layer, wherein the second format layout indicates a second layout of one or more color components of the second data within the color space; and
overlaying the surface and the second surface based on an overlay order.

11. The method of claim 10, wherein:
the surface comprises a two-dimensional surface, a three-dimensional surface, or a video surface; and
the second surface comprises a two-dimensional surface, a three-dimensional surface, or a video surface.

12. The method of claim 1, wherein creating the surface within the color space comprises providing sampling configuration information for the data that is associated with the surface.

13. The method of claim 1, further comprising:
performing surface rendering of the surface to generate the data associated with the surface; and
storing the data according to the format layout.

14. The method of claim 1, wherein the method is performed by one or more processors, and wherein each of the one or more processors comprises a display processor, a graphics processor, or a control processor.

15. A computer-readable medium comprising instructions for causing one or more programmable processors to:
create a graphics surface via a platform interface layer that lies between a client rendering application program interface (API) and a native platform rendering API; and
specify a format layout of data associated with the surface within a color space using the platform interface layer, wherein the format layout indicates a layout of one or more color components of the data associated with the surface within the color space.

16. The computer-readable medium of claim 15, wherein:
the platform interface layer comprises an embedded graphics library (EGL) layer; and
the client rendering API comprises an Open Graphics Library (OpenGL) API or an Open Vector Graphics (OpenVG) API.

17. The computer-readable medium of claim 15, wherein:
the color space comprises a luma, blue chroma difference, red chroma difference (YCbCr) color space;
the surface comprises a YCbCr surface; and
the format layout indicates the ordering of individual Y, Cb, and Cr components of the data.

18. The computer-readable medium of claim 15, wherein the format layout indicates a first layout of a first group of the one or more color components within a first plane, and wherein the format layout further indicates a second layout of a second group of the one or more color components within a second plane that is different from the first plane.

19. The computer-readable medium of claim 18, wherein the first group includes a plurality of the one or more color components, and wherein the first layout indicates an ordering of the plurality of color components of the first group within the first plane.

20. The computer-readable medium of claim 15, further comprising instructions for causing the one or more processors to:
store the data associated with the surface; and
store the format layout of the data as format data.

21. The computer-readable medium of claim 15, further comprising instructions for causing the one or more processors to:
provide the format layout of the data associated with the surface as pattern information to a processor for purposes of displaying the surface on a display device.

22. The computer-readable medium of claim 15, further comprising instructions for causing the one or more processors to:
specify color conversion information for use in converting the data associated with the surface into converted data within a different color space.

23. The computer-readable medium of claim 22, wherein:
the color space comprises a luma, blue chroma difference, red chroma difference (YCbCr) color space;
the different color space comprises a red, green, blue (RGB) color space; and
the converted data comprises RGB surface data.

24. The computer-readable medium of claim 15, further comprising instructions for causing the one or more processors to:
create a second surface within the color space using the platform interface layer;
specify a second format layout of second data associated with the second surface within the color space using the platform interface layer, wherein the second format layout indicates a second layout of one or more color components of the second data within the color space; and
overlay the surface and the second surface based on an overlay order.

25. The computer-readable medium of claim 24, wherein:
the surface comprises a two-dimensional surface, a three-dimensional surface, or a video surface; and
the second surface comprises a two-dimensional surface, a three-dimensional surface, or a video surface.

26. The computer-readable medium of claim 15, wherein the instructions for causing the one or more processors to create the surface within the color space comprise instructions for causing the one or more processors to provide sampling configuration information for the data that is associated with the surface.

27. The computer-readable medium of claim 15, further comprising instructions for causing the one or more processors to:
perform surface rendering of the surface to generate the data associated with the surface; and
store the data according to the format layout.

28. A device comprising:
a storage device configured to store surface information; and
one or more processors configured to create a graphics surface via a platform interface layer that lies between a client rendering application program interface (API) and a native platform rendering API,
wherein the one or more processors are further configured to specify a format layout of data associated with the surface within a color space using the platform interface layer, the format layout indicating a layout of one or more color components of the data associated with the surface within the color space, and to store the format layout within the surface information of the storage device.

29. The device of claim 28, wherein:
the platform interface layer comprises an embedded graphics library (EGL) layer; and
the client rendering API comprises an Open Graphics Library (OpenGL) API or an Open Vector Graphics (OpenVG) API.

30. The device of claim 28, wherein:
the color space comprises a luma, blue chroma difference, red chroma difference (YCbCr) color space;
the surface comprises a YCbCr surface; and
the format layout indicates the ordering of individual Y, Cb, and Cr components of the data associated with the surface.

31. The device of claim 28, wherein the format layout indicates a first layout of a first group of the one or more color components within a first plane, and wherein the format layout further indicates a second layout of a second group of the one or more color components within a second plane that is different from the first plane.

32. The device of claim 31, wherein the first group includes a plurality of the one or more color components, and wherein the first layout indicates an ordering of the plurality of color components of the first group within the first plane.

33. The device of claim 28, wherein the one or more processors are further configured to store the data associated with the surface in the storage device and to store the format layout of the data associated with the surface as format data in the storage device.

34. The device of claim 28, further comprising a display device, wherein the one or more processors are further configured to provide the format layout of the data associated with the surface as pattern information for purposes of displaying the surface on the display device.

35. The device of claim 28, wherein the one or more processors are further configured to specify color conversion information for use in converting the data associated with the surface into converted data for a different color space.

36. The device of claim 35, wherein:
the color space comprises a luma, blue chroma difference, red chroma difference (YCbCr) color space;
the different color space comprises a red, green, blue (RGB) color space; and
the converted data comprises RGB surface data.

37. The device of claim 28, wherein the one or more processors are further configured to create a second surface within the color space using the platform interface layer, to specify a second format layout of second data associated with the second surface within the color space using the platform interface layer, and to overlay the surface and the second surface based on an overlay order, wherein the second format layout indicates a second layout of one or more color components of the second data within the color space.

38. The device of claim 37, wherein:
the surface comprises a two-dimensional surface, a three-dimensional surface, or a video surface; and
the second surface comprises a two-dimensional surface, a three-dimensional surface, or a video surface.

39. The device of claim 28, wherein when the one or more processors are configured to create the surface within the color space, the one or more processors are further configured to provide sampling configuration information for the data that is associated with the surface.

40. The device of claim 28, wherein the one or more processors are further configured to perform surface rendering of the surface to generate the data associated with the surface, and to store the data according to the format layout.

41. The device of claim 28, wherein each of the one or more processors comprises a display processor, a graphics processor, or a control processor.

42. The device of claim 28, wherein the device comprises a wireless communication device handset, a personal computer, or a laptop device.

43. The device of claim 28, wherein the device comprises one or more integrated circuit devices.

44. A device comprising:
means for creating a graphics surface via a platform interface layer that lies between a client rendering application program interface (API) and a native platform rendering API; and
means for specifying a format layout of data associated with the surface within a color space using the platform interface layer, wherein the format layout indicates a layout of one or more color components of the data associated with the surface within the color space.

45. The device of claim 44, wherein:
the platform interface layer comprises an embedded graphics library (EGL) layer; and
the client rendering API comprises an Open Graphics Library (OpenGL) API or an Open Vector Graphics (OpenVG) API.

46. The device of claim 44, wherein:
the color space comprises a luma, blue chroma difference, red chroma difference (YCbCr) color space;
the surface comprises a YCbCr surface; and
the format layout indicates the ordering of individual Y, Cb, and Cr components of the data.

47. The device of claim 44, wherein the format layout indicates a first layout of a first group of the one or more color components within a first plane, and wherein the format layout further indicates a second layout of a second group of the one or more color components within a second plane that is different from the first plane.

48. The device of claim 47, wherein the first group includes a plurality of the one or more color components, and wherein the first layout indicates an ordering of the plurality of color components of the first group within the first plane.

49. The device of claim 44, further comprising:
means for storing the data associated with the surface; and
means for storing the format layout of the data as format data.

50. The device of claim 44, further comprising:
means for providing the format layout of the data associated with the surface as pattern information to a processor for purposes of displaying the surface on a display device.

51. The device of claim 44, further comprising:
means for specifying color conversion information for use in converting the data associated with the surface into converted data within a different color space.

52. The device of claim 51, wherein:
the color space comprises a luma, blue chroma difference, red chroma difference (YCbCr) color space;
the different color space comprises a red, green, blue (RGB) color space; and
the converted data comprises RGB surface data.

53. The device of claim 44, further comprising:
means for creating a second surface within the color space using the platform interface layer;
means for specifying a second format layout of second data associated with the second surface within the color space using the platform interface layer, wherein the second format layout indicates a second layout of one or more color components of the second data within the color space; and
means for overlaying the surface and the second surface based on an overlay order.

54. The device of claim 53, wherein:
the surface comprises a two-dimensional surface, a three-dimensional surface, or a video surface; and
the second surface comprises a two-dimensional surface, a three-dimensional surface, or a video surface.

55. The device of claim 44, wherein the means for creating the surface within the color space comprises means for providing sampling configuration information for the data that is associated with the surface.

56. The device of claim 44, further comprising:
means for performing surface rendering of the surface to generate the data associated with the surface; and
means for storing the data according to the format layout.
